(19) United States
(12) Patent Application Publication
(10) Pub. No.: US 2021/0268917 A1
(43) Pub. Date: Sep. 2, 2021

(54) FUEL CELL SYSTEM FOR A MOTOR VEHICLE

(71) Applicant: Robert Bosch GmbH, Stuttgart (DE)

(72) Inventors: Joerg HEYSE, Besigheim (DE); Markus REMLINGER, Miesbach (DE); Saskia BOSTELMANN, Stuttgart (DE); Werner BELSCHNER, Michelbach An Der Bilz (DE)

(21) Appl. No.: 17/259,297

(22) PCT Filed: Jun. 27, 2019
(86) PCT No.: PCT/EP2019/067209

§ 371 Date: Jan. 11, 2021

(30) Foreign Application Priority Data
Jul. 10, 2018 (DE) 10 2018 211 408.0

(51) Int. Cl. B60L 50/72; H01M 8/04007; H01M 8/04082; H01M 8/04701; B60L 58/33

(52) U.S. Cl. CPC B60L 50/72; H01M 8/04007; H01M 2250/20; H01M 8/04701; B60L 58/33; H01M 8/04201

(57) ABSTRACT

The present invention relates to a fuel cell system (10) for a motor vehicle, and to a motor vehicle which has a fuel cell system (10) of this kind. In this case, the fuel cell system (10) comprises a cooling module (14), an electrical drive module (18), a fuel tank module (22) and at least one fuel cell apparatus (26). In this case, the fuel cell apparatus (26) comprises a fuel cell (30), a cooling connection unit (38) which is connected to the fuel cell (30), wherein the cooling connection unit (38) has cooling connections (50) by way of which the fuel cell apparatus (26) can be connected to the cooling module (14) so that the fuel cell apparatus (26) can be cooled by means of the cooling module (14), power connections (34) which are connected to the fuel cell (30) so that the fuel cell apparatus (26) can be connected to the electrical drive module (18) and the electrical drive module (18) can be supplied with power, an air connection unit (54) which is connected to the fuel cell (30), wherein the air connection unit (54) has air connections (62) by means of which air can be supplied to and discharged from the fuel cell apparatus (26), and a fuel supply unit (66) which is connected to the fuel cell (30), wherein the fuel supply unit (66) has a fuel connection (70) by way of which the fuel cell apparatus (26) can be connected to the fuel tank module (74) so that fuel can be supplied to the fuel cell (30).

### BACKGROUND OF THE INVENTION

The present invention relates to a fuel cell system for a motor vehicle, and to a motor vehicle which has a fuel cell system of said type.

Fuel cell systems are used in particular in fuel cell vehicles. In such vehicles, the fuel is converted by means of the fuel cell into electrical energy for driving an electric drive motor and/or charging an energy store. In order to ensure the operation of the fuel cell, the fuel cell is in this case connected to the fuel tank via a fuel path with flow rate control. The electrical current is in this case conducted either into the electrical energy store or to the electric drive motor in accordance with demand via circuits. The fuel cell is advantageously connected to a cooling system such that the fuel cell can be brought to operating temperature more quickly, or that the fuel cell can be cooled.

A fuel cell system for a hybrid-electric or fuel-cell vehicle is known from DE 10 2011 076 737 A1.

The background to the invention lies in the fact that a new fuel cell system has to be developed for vehicles with different levels of required power. The use of fuel cell systems in vehicles is thus expensive.

### SUMMARY OF THE INVENTION

It is therefore the object of the present invention to specify a fuel cell system for motor vehicles, which fuel cell system can be used in motor vehicles more economically.

The object is achieved by means of a fuel cell system having the features of the invention. The dependent claims specify advantageous refinements of the invention.

The invention specifies a fuel cell system for a motor vehicle, wherein the fuel cell system comprises a cooling module, an electric drive module, a fuel tank module and at least one fuel cell device. Here, the fuel cell device comprises a fuel cell, a cooling connection unit which is connected to the fuel cell, wherein the cooling connection unit has cooling connections by means of which the fuel cell device is connectable to the cooling module, such that the fuel cell device can be cooled by means of the cooling module, electrical current connections which are connected to the fuel cell such that the fuel cell device is connectable to the electric drive module and the electric drive module can be supplied with electrical current, an air connection unit which is connected to the fuel cell, wherein the air connection unit has air connections via which air can be fed to and discharged from the fuel cell device, and a fuel feed unit which is connected to the fuel cell, wherein the fuel feed unit has a fuel connection by means of which the fuel cell device is connectable to the fuel tank module such that fuel can be fed to the fuel cell.

In the context of the invention, a module is to be understood to mean a self-contained unit which is connected for example to other modules only by means of a small number of connections.

The modular construction of the fuel cell system makes it possible that, for the use of said system in a motor vehicle, only the cooling module, the electric drive module, which preferably comprises a high-voltage energy store, and the fuel tank module have to be adapted to the vehicle-specific circumstances. The fuel cell device, which forms the core part of the fuel cell system, can be used unchanged for different motor vehicles. The fuel cell device thus also does not require any renewed expensive technical acceptance and certification. The use of the fuel cell system according to the invention is thus possible economically even for different motor vehicles.

By means of the modular construction of the fuel cell system, it is possible for the various modules to be positioned in the motor vehicle more in accordance with requirements. In this way, the modules can be positioned with regard to better accessibility and ease of maintenance. Furthermore, in the event of a fault in one module, it is not necessary for the entire fuel cell system to be exchanged; it is merely necessary for the faulty module to be exchanged.

In one preferred embodiment of the invention, the fuel cell system has at least two fuel cell devices which are interconnected in parallel with one another. By means of an interconnection of the fuel cell devices, the power can be increased without modifying the fuel cell device. In this way, the different power required for different motor vehicles can be implemented in a simple and economical manner.

In a further preferred embodiment of the invention, the cooling module, the drive module and/or the fuel tank module are adapted for connection to a motor vehicle infrastructure. In this way, the fuel cell system is connectable to different motor vehicles. However, owing to the modular construction, the adaptation is limited to a small number of simple connections, such as electrics, cooling water, air feed, hydrogen feed and mounting. In this way, a straightforward adaptation to the vehicle infrastructure is possible. The costs for adaptation to different motor vehicles are thus reduced.

A number of fuel cell devices is preferably selected in accordance with the drive power of the motor vehicle. In order to obtain a particular drive power, it is thus merely necessary to increase the number of fuel cell devices. In this way, any level of drive power can be attained without modifying the fuel cell device. This allows a fast and economical provision of fuel cell systems for motor vehicles with different levels of drive power.

The drive module is preferably configured in accordance with a drive power of the motor vehicle. In this way, an adequate drive power for the propulsion of the motor vehicle can be provided.

The cooling module is advantageously configured in accordance with the number of fuel cell devices. In this way, an adequate cooling power for cooling or preheating the fuel cells is achieved.

In one advantageous refinement, the fuel tank module is configured in accordance with the number of fuel cell devices and a range of the motor vehicle. In this way, it is also possible for sufficient fuel for an intended range to be provided for the fuel cell devices.

The object of the invention is additionally achieved by means of a motor vehicle having the fuel cell system according to the invention.

The advantages stated with regard to the fuel cell system can thus be achieved with the motor vehicle.

### BRIEF DESCRIPTION OF THE DRAWINGS

Exemplary embodiments of the invention are illustrated in the drawing and discussed in more detail in the following description.

In the drawing:

FIG. 1 is an illustration of a fuel cell system according to the invention for a motor vehicle according to a first exemplary embodiment; and

FIG. 2 is an illustration of a fuel cell system according to the invention for a motor vehicle according to a second exemplary embodiment.

### DETAILED DESCRIPTION

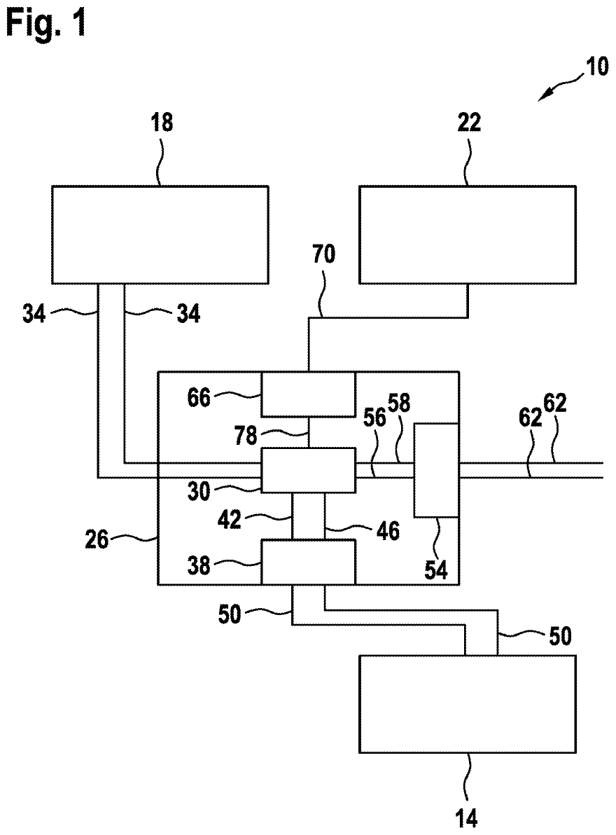

FIG. 1 shows a fuel cell system 10 for a motor vehicle according to a first exemplary embodiment of the invention. The fuel cell system 10 comprises a cooling module 14, an electric drive module 18, a fuel tank module 22 and a fuel cell device 26. The cooling module 14, the electric drive module 18 and the fuel tank module 22 are in this case adapted to the specific vehicle in order to be connectable to connections of the motor vehicle. Here, the cooling module 14 has a cooling circuit by means of which the cooling medium can be cooled. The electric drive module 18 comprises at least one electric drive motor, by means of which the motor vehicle can be driven, and optionally a high-voltage energy store, in which the electrical energy can be stored. The fuel required for a fuel cell 30 is stored in the fuel tank module 22.

The fuel cell device 26 comprises the fuel cell 30, which is connectable by means of electrical current connections 34 to the electric drive module 18 and which supplies electrical current to the electric drive module 18. The fuel cell device 26 additionally comprises a cooling connection unit 38 which is connected via a cooling feed line 42 and a cooling discharge line 46 to the fuel cell 30. The cooling connection unit 38 has cooling connections 50 by means of which the fuel cell device 26 is connectable to the cooling module 14. In the cooling connection unit 38, the cooling medium received from the cooling module 14 is prepared such that it can be fed directly via the cooling feed line 42 for the purposes of cooling the fuel cell 30. The heated cooling medium is recirculated to the cooling module 14 via the cooling discharge line 46, the cooling connection unit 38 and the cooling connections 50. The fuel cell device 26 furthermore comprises an air connection unit 54 which is connected via an air feed line 56 and an air discharge line 58 to the fuel cell 30. In the air connection unit 54, the ambient air fed via the air connections 62 is prepared such that it can be fed to the fuel cell 30. The consumed air is released to the environment via the air discharge line 58, the air connection unit 54 and the air connections 62. The fuel cell device 26 comprises a fuel feed unit 66 which is connected via a fuel connection 70 to the fuel tank module 22. In the fuel feed unit 66, the fuel for the fuel cell 30 is prepared such that the fuel can be released directly to the fuel cell 30 via a fuel feed line 78.

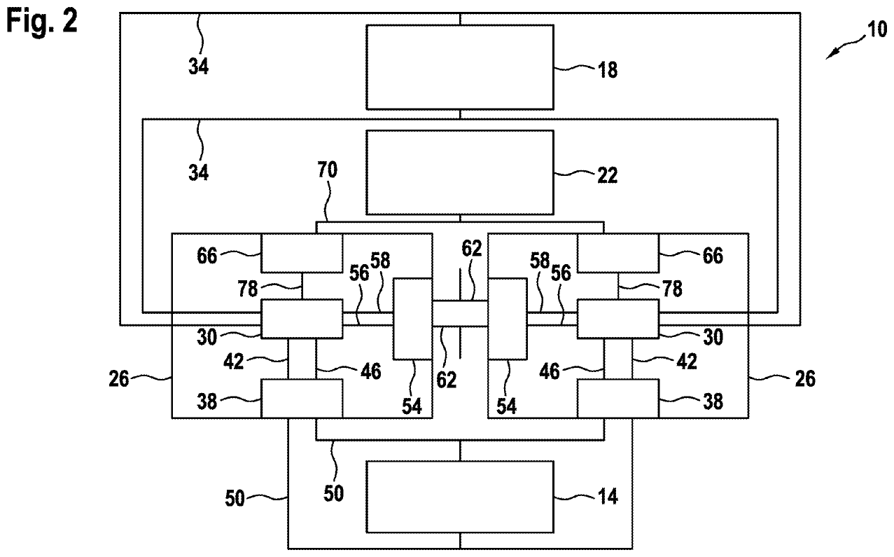

FIG. 2 shows a fuel cell system 10 for a motor vehicle according to a second exemplary embodiment of the invention. Said exemplary embodiment differs from the first exemplary embodiment in particular by the fact that two fuel cell devices 26 are used. The construction of the other modules 14, 18, 22 however remains the same. Here, the two fuel cell devices 26 are connected to one another in parallel. In this way, twice the power in relation to a single fuel cell device 26 is attained. It is thus possible for the power to be increased by means of an arrangement of multiple fuel cell devices 26.

1. A fuel cell system (10) for a motor vehicle, the fuel cell system comprising a cooling module (14), an electric drive module (18), a fuel tank module (22) and at least one fuel cell device (26), wherein the fuel cell device (26) comprises:
a fuel cell (30),
a cooling connection unit (38) which is connected to the fuel cell (30), wherein the cooling connection unit (38) has cooling connections (50) configured to connect the fuel cell device (26) to the cooling module (14), such that the fuel cell device (26) can be cooled by means of the cooling module (14),
electrical current connections (34) which are connected to the fuel cell (30) such that the fuel cell device (26) is connectable to the electric drive module (18) and the electric drive module (18) can be supplied with electrical current,
an air connection unit (54) which is connected to the fuel cell (30), wherein the air connection unit (54) has air connections (62) configured to feed air to and discharge air from the fuel cell device (26), and
a fuel feed unit (66) which is connected to the fuel cell (30), wherein the fuel feed unit (66) has a fuel connection (70) configured to connect the fuel cell device (26) to the fuel tank module (74) such that fuel can be fed to the fuel cell (30).

2. The fuel cell system (10) as claimed in claim 1, characterized in that the fuel cell system (10) has at least two fuel cell devices (26) which are interconnected in parallel with one another.

3. The fuel cell system (10) as claimed in claim 1, characterized in that the cooling module (14), the drive module (18) and/or the fuel tank module (74) are configured to be connected to a motor vehicle infrastructure.

4. The fuel cell system (10) as claimed in claim 1, characterized in that a number of fuel cell devices (26) is selected in accordance with a drive power of the motor vehicle.

5. The fuel cell system (10) as claimed in claim 1, characterized in that the drive module (18) is configured in accordance with a drive power of the motor vehicle.

6. The fuel cell system (10) as claimed in claim 1, characterized in that the cooling module (14) is configured in accordance with a number of fuel cell devices (26).

7. The fuel cell system (10) as claimed in claim 1, characterized in that the fuel tank module (74) is configured in accordance with a number of fuel cell devices (26) and a range of the motor vehicle.

8. A motor vehicle having a fuel cell system (10) as claimed in claim 1.

9. The fuel cell system (10) as claimed in claim 2, characterized in that the cooling module (14), the drive module (18) and/or the fuel tank module (74) are configured to be connected to a motor vehicle infrastructure.

10. The fuel cell system (10) as claimed in claim 9, characterized in that a number of fuel cell devices (26) is selected in accordance with a drive power of the motor vehicle.

11. The fuel cell system (10) as claimed in claim 10, characterized in that the drive module (18) is configured in accordance with the drive power of the motor vehicle.

12. The fuel cell system (10) as claimed in claim 11, characterized in that the cooling module (14) is configured in accordance with the number of fuel cell devices (26).

13. The fuel cell system (10) as claimed in claim 12, characterized in that the fuel tank module (74) is configured in accordance with the number of fuel cell devices (26) and a range of the motor vehicle.
